(19) United States
(12) Patent Application Publication
(10) Pub. No.: US 2025/0376890 A1
(43) Pub. Date: Dec. 11, 2025

(54) FENESTRATION PANELS AND SYSTEMS

(71) Applicant: VKR HOLDING A/S, 2970 HORSHØLM (DK)

(72) Inventors: Sean Timothy Flanigan, Falmouth, ME (US); Jeffery Joseph Ronan, Greenwood, SC (US); Brian Jefferson Burkes, Greenwood, SC (US); Cory Richard Boudreau, Lake Mills, WI (US); Max Bock-Aronson, Somerville, MA (US)

(21) Appl. No.: 19/229,309

(22) Filed: Jun. 5, 2025

Related U.S. Application Data
(60) Provisional application No. 63/656,808, filed on Jun. 6, 2024.
(60) Provisional application No. 63/659,196, filed on Jun. 12, 2024.

(51) Int. Cl. E06B 3/20; E04C 1/42; E06B 3/66

(52) U.S. Cl. CPC E06B 3/20; E04C 1/42; E06B 3/6621; E06B 3/66366

(57) ABSTRACT

A fenestration panel system comprises first and second fenestration panels, each having opposing side edges and each having an exterior surface and an opposing interior surface. A first profile is carried by a side edge of the first panel and a second profile is carried by a side edge of the second panel. A connector is coupled to each of the first and second profiles and a clamping bar is attached to the connector. The connector resides proximate to one of the surfaces and the clamping bar residing opposite the connector and proximate to the other of the surface. Each fenestration panel may be greater than thirty-five inches (889 millimeters) in width. The second panel is removable from the system without removal of the first panel. A third hand may be attached to one of the fenestration panels to aid in installation.

### CROSS-REFERENCE TO RELATED APPLICATIONS

This application claims the benefit of priority of U.S. Provisional Application Ser. No. 63/656,808, filed on Jun. 6, 2024, and U.S. Provisional Application Ser. No. 63/659,196, filed on Jun. 12, 2024, which are incorporated herein in their entireties.

### BACKGROUND OF THE INVENTION

Fenestration encompasses the openings within a building's envelope, including windows, curtain walls, and skylights, designed to allow light transmission while preserving structural integrity and enhancing energy efficiency. These openings are fitted with panels that serve both functional and aesthetic purposes. Typically, fenestration panels consist of glazing systems or translucent/transparent panels integrated into these openings.

Fenestration panels are often manufactured from materials such as glass, polycarbonate, or acrylic. They can include single, double, or triple glazing to enhance insulation properties. Additionally, these panels may feature coatings designed to reduce heat transfer, as well as tinted or frosted finishes to ensure privacy.

Modern fenestration panels may have several advantageous properties, including (a) high light transmission, allowing natural daylight into a building interior and thus reducing artificial lighting needs, creating open, well-lit spaces; (b) engineered thermal performance to improve energy efficiency, reducing heating and cooling loads; (c) aesthetic flexibility, with availability in various tints, textures, and finishes to match architectural designs; and (d) weather resistance to withstand wind, rain, and temperature fluctuations.

One example of a fenestration panel is a multiwall panel, typically made from polycarbonate or acrylic and consisting of multiple layers (or “walls”) separated by air channels, creating a lightweight, insulating, and durable panel system. These panels feature a cellular structure with two or more walls connected by ribs, forming air pockets that enhance insulation. They are available in various thicknesses and configurations (e.g., twin-wall, triple-wall, or more), with options for UV-resistant coatings, fire-retardant properties, and customizable colors or translucency levels. The air channels in multiwall panels provide thermal resistance, reducing energy costs. They are typically lightweight-significantly lighter than glass-which eases installation and structural requirements. At the same time, multiwall panels are far stronger than glass, resisting hail, windborne debris, and other impacts.

Another example of a fenestration panel is an “FRP” (fiberglass reinforced plastic) panel. FRP panels are composite materials made of a polymer matrix reinforced with fiberglass, and are known for their high strength-to-weight ratio, durability, corrosion resistance, minimal maintenance, and long service life. FRP panels combine fiberglass (woven roving, mats, or veils) with resins (e.g., polyester, epoxy) to create strong, lightweight panels. They come in various finishes (smooth, textured, or patterned), colors, and thicknesses. They have high impact and abrasion resistance, and high moisture and chemical resistance. Like multiwall panels, FRP panels are typically lightweight. FRP panels are also quite durable, affordable, and low-maintenance.

Fenestration panels have been installed in building opening and skylights in various ways. Various techniques for doing so are purportedly disclosed, for examples, in aspects of U.S. Pat. Nos. 12,000,146; 11,993,929; 11,377,847; 11,131,093; 10,975,566; 10,767,414; 10,753,085; 10,669,712; 10,557,303; 9,151,056; 8,800,223, 8,584,424; 8,544,223; and 8,448,393, and U. S. Published App. Nos. 2023/0228082 and 2013/0097952. The known systems, however, including those identified in this paragraph, have been found lacking in a number of respects. It would be advantageous to provide fenestration panels and systems that:
have a single common structure, with the same installation methods, for use in mounting various types of fenestration panels to buildings;
provide for a scalable structure;
build structural support into the fenestration panel;
include a structural framework that is intuitive for installers and versatile for architects and designers;
have a uniform structure for capture of the edges of a fenestration panel;
permit structurally reliably panel widths of up to forty-eight inches (1219 millimeters);
simplify installation by providing a mechanism to hold the panel in place in a building opening during the installation process;
are designed for both vertical (“curtainwall”) and sloped applications;
minimize the use of adhesive tapes, caulks, and sealants; and
allow for removal of individual panels anywhere along the width of a multi-panel installation without removal of other panels.

### SUMMARY OF THE INVENTION

New fenestration panels and associated systems for mounting such fenestration panels have been discovered that provide durable, efficient, reliable, and simple yet versatile solutions to the difficulties and shortcoming encountered before.

This Summary of the Invention neither is intended to be nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description. No limitation as to the scope of the present invention is intended by either the inclusion or non-inclusion of elements, components, connections, and interrelationships of same in this Summary of the Invention.

In accordance with certain aspects of certain embodiments of the present invention, a fenestration panel system may include a fenestration panel having side edges. Profile means, structures for which being expressly disclosed in the Detailed Description, may provide for attachment to a side edge of the fenestration panel. A connector may be configured to engage with the profile means. A clamping element may be configured to engage with the profile means and with the connector. Additionally, and/or alternatively, in various embodiments one or more of the following features may also be included:
the fenestration panel resides sloped;
the fenestration panel greater than thirty-five inches (889 millimeters) in width;
further including a third hand configured for attachment to the fenestration panel;
the fenestration panel is a multiwall panel having two glazing units;
further including an intermediate connector disposed within the panel and between the side edges; and/or
the fenestration panel system is devoid of tape, caulk, and sealant.
the fenestration panel is a multiwall panel having two glazing units, each glazing unit carries a hook residing proximate to a side edge, each of the hooks extends toward the other glazing unit, and both hooks are connected to the profile means.

In accordance with additional aspects of other embodiments of the present invention, a fenestration panel system may include a fenestration panel having a first side, a opposite second side, and a side edge between the first and second sides. A profile may be carried by the side edge, the profile including a first overlap extending outboard from the profile. A connector may have a second overlap extending outboard from the connector and may e configured to interfit with the first overlap to mate the connector with the profile. A clamping element may be configured for attachment to the connector. Additionally, and/or alternatively, in various embodiments one or more of the following features may also be included:
upon mating the connector with the profile and attaching the clamping element to the connector, the connector resides proximate to the first side and the clamping element resides proximate to the second side;
the profile includes an aperture adapted for receipt of a fastener from the clamping element;
the system resides in a sloped orientation;
the fenestration panel is a multiwall panel having two glazing units, each glazing unit carrying a hook that resides proximate to the same side edge, each hook extends toward the other glazing unit, and both hooks are interfitted with the profile;
the fenestration panel is fabricated of fiberglass reinforced plastic; and/or
an intermediate connector resides within the panel and distal to the side edge.

In accordance with yet additional aspects of other embodiments of the present technology, a fenestration panel system may include first and second fenestration panels, each such panel having opposing side edges and each having an exterior surface and an opposing interior surface. A first profile may be carried by a side edge of the first panel and a second profile may be carried by a side edge of the second panel. The first and second profiles may be identical to each other. A connector may be coupled to each of the first and second profiles. A a clamping bar may be attached to the connector. The connector may reside proximate to one of the exterior surface and the interior surface, and the clamping bar may reside opposite the connector and proximate to the other of the exterior surface and the interior surface.

Additionally, and/or alternatively, in various embodiments one or more of the following features may also be included:
each fenestration panel is greater than thirty-five inches (889 millimeters) in width;
the second panel is removable from the fenestration panel system without removal of the first panel;
further including a third hand attached to one of the fenestration panels; and/or
the connector and the first profile provide a gap between them that allows a functional tolerance.

Engineered fenestration panels and systems are thus provided. In some embodiments, the panel may be a multiwall panels, while in other embodiments, the panel may FRP. The panels may be connected to a building, or connected to each other, by profiles, which may be fabricated from aluminum, fiberglass, plastic, or other suitable material or materials.

More specifically as to multiwall panels, the panel assembly may comprise inner and outer glazing units connected together with profiles along the edges. In some embodiments, the inner and outer glazing units may also be connected together by intermediate connectors at one or more intermediate points between the side edges. The edge profiles may include an interlocking detail that creates one-half of a hook feature that is a part of the system's connection and clamping design, to mate with a profile residing on an adjacent panel. A side edge of each panel may have the connector profile screwed or otherwise fastened in place. This profile includes an overlap detail. An aesthetic cover may also be attached to the assembly. In an application with plural fenestration panels side-by-side, as each panel is installed the overlap and hook features mate, creating a positive connection between the panels and securely clamping the side edges of the multiwall extrusions into the mating profiles. A clamping bar may then be screwed in place. The clamping bar may have an overlap feature facing the opposite way as the connector profile, providing a stronger panel-to-panel connection than a flat clamp bar. An aesthetic cover may and be installed, and the process is repeated for each successive panel in the installation. Additional features relevant to this assembly include (1) the greater strength of the panel design allows for a panel width of up to twice that of conventional systems; (2) designed for both vertical (“curtainwall”) and sloped applications; (3) individual panels can be removed and replaced anywhere along the width of the unit of a multi-panel assembly without removal of other panels; and (4) the panel assembly uses less adhesive tapes, caulks, and/or sealants.

More specifically as to panels assembled from fiberglass reinforced plastics, a glazing panel assembly may comprise inner and outer fiberglass reinforced plastic sheets adhered to an internal grid construction comprising metal or fiberglass structural profiles. Side edge profiles may include an interlocking overlap detail that creates one-half of a feature that is a part of the system's connection and clamping design, allowing for edge-to-edge attachment of two or more panels. A side edge of each panel may have a connector profile screwed or otherwise fastened in place, facing the interior. An internal aesthetic cover may be integrated into the connector profile. The overlap features of adjacent panels may engage, creating a positive connection between the panels. A clamping bar may then be fastened into place between the two adjacent panels. The clamping bar may also have the overlap feature facing the opposite way as the connector profile to provide a stronger panel-to-panel connection than does a flat clamp bar. A snap-on aesthetic cover may be installed last, and the process is repeated for each successive panel in the unit. Additional features relevant to this assembly include (1) the greater strength of the panel design allows for standard panel widths up to forty inches; (2) designed for both vertical (“curtainwall”) and sloped applications; (3) individual panels can be removed and replaced anywhere along the width of the unit of a multi-panel assembly without removal of other panels; and (4) connector and cover profiles include inserted flexible seals to provide multi-point weather protection

Additional objects and advantages of the present subject matter are set forth in, or will be apparent to, those of ordinary skill in the art from the Detailed Description herein. Also, it should be further appreciated that modifications and variations to the specifically illustrated and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

The purpose of the Abstract included herewith is only to enable the United States Patent and Trademark Office and the public generally to determine quickly from a cursory inspection the nature and gist of the technical disclosure. The Abstract is not provided for interpreting the scope of the claims herein, nor to define the invention or the application, nor to be limiting in any way as to the scope of the invention.

### BRIEF DESCRIPTION OF DRAWINGS

The details of the present invention, as to both its structure and its operation, can be understood with reference to the accompanying drawings, in which:

FIG. 1 is a simplified perspective view of a fenestration panel with attached edge profiles according to an exemplary embodiment of the present invention;

FIG. 2 is a cross-sectional view, taken at E:E of FIG. 1, of a fenestration panel and fittings according to an exemplary embodiment of the present invention;

FIG. 3 is a partial cross-sectional view of side edges, one of which is taken at F:F of FIG. 1, of two fenestration panels and fittings according to an exemplary embodiment of the present invention;

FIG. 4 is a partial cross-sectional view of side edges, one of which is taken at F:F of FIG. 1, of two fenestration panels and fittings according to an exemplary embodiment of the present invention;

FIG. 5 is a partial cross-sectional view of side edges, one of which is taken at F:F of FIG. 1, of two fenestration panels and fittings according to an exemplary embodiment of the present invention;

FIG. 6 is a cross-sectional view, taken at E:E of FIG. 1, of a fenestration panel and fittings according to an exemplary embodiment of the present invention;

FIG. 7 is an enlarged cross-sectional view, taken at G in FIG. 6, of a fenestration panel and a fitting according to an exemplary embodiment of the present invention;

FIG. 8 is a cross-sectional view of a profile for a fenestration panel edge according to an exemplary embodiment of the present invention;

FIG. 9 is a cross-sectional view of a profile for a fenestration panel edge according to an exemplary embodiment of the present invention;

FIG. 10 is a cross-sectional view of a profile for a fenestration panel edge according to an exemplary embodiment of the present invention;

FIG. 11 is a cross-sectional view, taken at E:E of FIG. 1, of a fenestration panel and fittings according to an exemplary embodiment of the present invention;

FIG. 12 is a partial cross-sectional view of side edges, one of which is taken at F:F of FIG. 1, of two fenestration panels and fittings according to an exemplary embodiment of the present invention;

FIG. 13 is a partial cross-sectional view of side edges, one of which is taken at F:F of FIG. 1, of two fenestration panels and fittings according to an exemplary embodiment of the present invention;

FIG. 14 is a partial cross-sectional view of side edges, one of which is taken at F:F of FIG.

1, of two fenestration panels and fittings according to an exemplary embodiment of the present invention;

FIG. 15 is a partial cross-sectional view of a bottom edge of a fenestration panel and fittings according to an exemplary embodiment of the present invention, illustrated in a condition of use;

FIG. 16 is a partial cross-sectional view of a top edge of a fenestration panel and fittings according to an exemplary embodiment of the present invention, illustrated in a condition of use;

FIG. 17 is a partial cross-sectional view of a top edge of a fenestration panel and fittings according to an exemplary embodiment of the present invention, illustrated in a condition of use;

FIG. 18 is a partial cross-sectional view of fenestration panels and fittings according to an exemplary embodiment of the present invention, illustrated in a condition of use;

FIG. 19 is a perspective view, from a lower perspective, of fittings for fenestration panels according to an exemplary embodiment of the present invention;

FIG. 20 is a perspective view of a hinge for a fenestration panel according to an exemplary embodiment of the present invention;

FIG. 21 is a partial cross-sectional view of a fenestration panel and fittings according to an exemplary embodiment of the present invention, illustrated in a condition of use; and

FIG. 22 is a partial cross-sectional view of fenestration panels and fittings according to an exemplary embodiment of the present invention.

It should be noted that the drawings discussed above and below are not to scale in all instances but may have exaggerated dimensions in some respects to illustrate principles of the invention.

### DETAILED DESCRIPTION

Embodiments and examples are disclosed herein, but the invention extends to alternatives, modifications, and equivalents beyond these examples. The claims below are not limited by any specific embodiments described. Methods or processes may be performed in any suitable order and are not restricted to any disclosed sequence. Structures, systems, and devices may be integrated or separate components. For comparison, certain aspects and advantages of these embodiments are described. Not all aspects or advantages are achieved by every embodiment. Various embodiments may optimize one advantage or group of advantages without necessarily achieving others.

It is to be understood that the phraseology used herein is for the purpose of description and should not be regarded as limiting. As to such phraseology, the following explanations apply to the disclosure herein:
The terms “include,” “comprise,” “have,” and formatives thereof are meant to encompass the items listed thereafter and equivalents thereof, as well as additional items.
The terms “connected” and “carried by,” unless specified or expressly limited otherwise, are used broadly and encompass direct and indirect mountings, connections, supports, or couplings. Further, such phraseology is not limited to physical or mechanical connections or couplings.
The terms “above” and “below,” “up” and “down,” “top” and “bottom,” “upward” and “downward,” and the like, are with gravitational reference when the present technology is in regular use. Thus, for example, a component is “above” another if, when the present technology is in regular use, that component is gravitationally higher than the other. Similarly, a first aspect may be considered “upper” and a second aspect may be considered “lower” when, in the regular use of the invention, the first aspect is gravitationally higher than the second aspect. Additionally, “height” and “high” refer to orientations parallel to gravity when the present technology is in regular use, whereas “width” and “wide” refer to orientations perpendicular to gravity when the present technology is in regular use.
The term “horizontal” means parallel to the horizon when the present technology is in regular use. The term “vertical” means perpendicular to the horizon when the present technology is in regular use.
The term “exterior” refers to the outside of a building space, while the term “interior” refers to the inside of a building space.
The term “integral” and variations thereof mean formed together as a unit, made as a single unit, formed of and as and in one piece, formed in a single piece, formed in the same process, of one-piece construction, formed of a unitary single piece, created as a single complete unit, and/or physically a one-piece construction. The term “integral” and variations thereof includes, but is not limited to, made from the same material and/or of the same composition. To further define the term “integral” and variations thereof as used herein, a component comprising two pieces that are individually made and then permanently affixed together are not “integral.” “Integral” may further be understood to not include within its definition “formed separately then combined or joined,” a separate element attached, “two or more distinct pieces that are permanently attached,” a separate element attached to, separate components that are integrated into one component, or separate components that are combined.
A rectangular fenestration panel may be considered to have a top edge and an opposite bottom edge, with two opposing side edges extending between the top edge and the bottom edge.

Embodiments of new fenestration panels and systems are described herein. The technology disclosed herein is applicable to a variety of fenestration panels. For purposes of illustration, and only for those purposes, two exemplary types of fenestration panels will be described in detail: (a) what will be referred to as a “multiwall panel” and (b) what will be referred to as an “FRP panel” (fiberglass reinforced plastic panel). However, the scope of the inventions herein disclosed should not be limited by these two particular embodiments, but should be determined only by a fair reading of the claims that may issue from the benefit of the within disclosure.

### A. Multiwall Panel

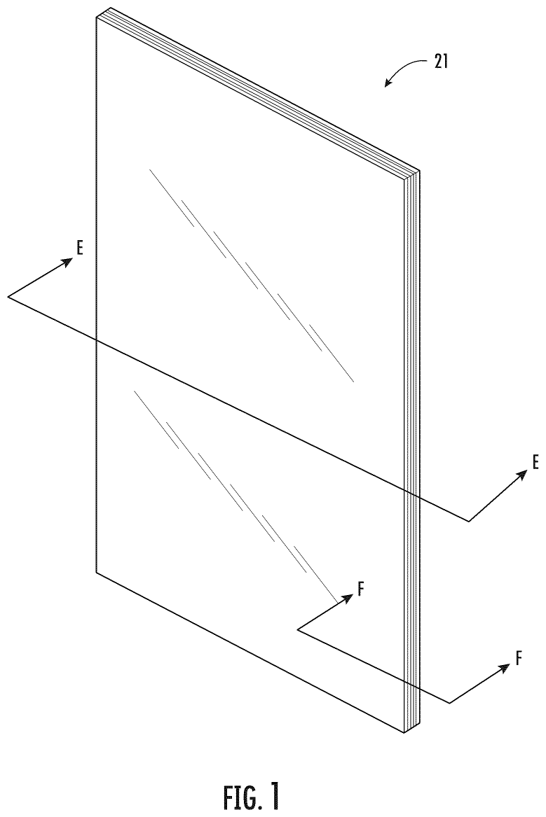

An example of a multiwall fenestration panel, such as a first panel 21, may include a first glazing unit 31 and a second glazing unit 32, both such glazing units being light transmitting structures, the first and second glazing units 31, 32 being separated from each other to create between them a spacing 35. FIG. 1 provides a simplified illustration of such a fenestration panel. The first glazing unit 31 may be understood to face the interior of a building and the second glazing unit 32 may be understood to face the exterior of that building. Each of the first and second glazing units 31, 32 may be transparent, translucent, opaque, or combinations of transparent, translucent, and opaque. Such a fenestration panel 21 may be oriented in a vertical configuration in an opening in a building, such as for a window, as for a curtain wall, or as for a light transmitting wall, or in a sloped configuration such as for a skylight.

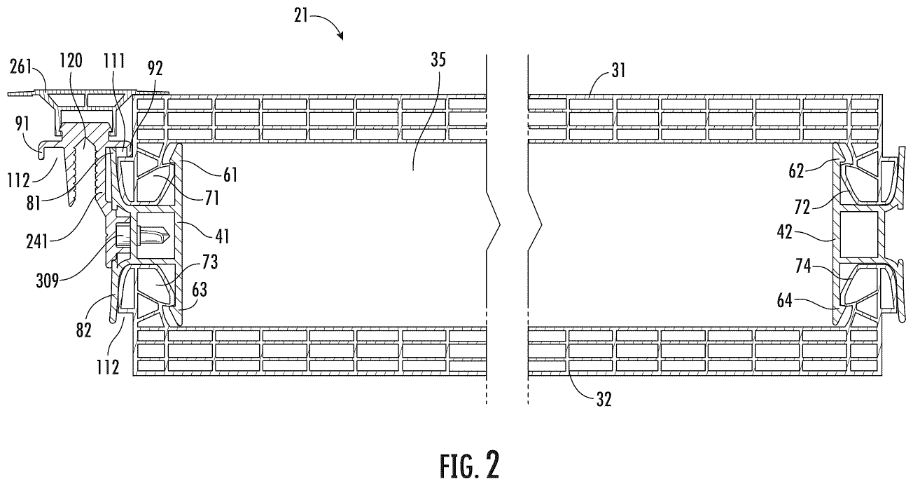

FIGS. 2-10 illustrate certain aspects of embodiments of such a vertical configuration of a multiwall system, which is described in detail hereinbelow. In a cross-sectional view of the first panel 21 such as FIGS. 2-5, at each side edge of the first glazing unit 31 may reside a hook, such as a first hook 71 at one edge and a second hook 72 at the opposite edge. Each of the first and second hooks 71, 72 may be integrally formed with the first glazing unit 31 or, alternatively, may be joined to the first glazing unit 31 after fabrication of the first glazing unit 31. Each of the first and second hooks 71, 72 may extend away from the first glazing unit 31 toward the second glazing unit 32. Each of the first and second hooks 71, 72 may extend along the entire height of the first glazing unit 31, or alternatively may extend along only a portion of the height of the first glazing unit 31, or still alternatively plural such hooks 71, 72 may reside intermittently along such height of the first glazing unit 31.

Similarly, at each side edge of the second glazing unit 32 there may be a hook, such as a third hook 73 at one edge and a fourth hook 74 at the opposite edge. Each of the third and fourth hooks 73, 74 may be integrally formed with the second glazing unit 32 or, alternatively, may be joined to the second glazing unit 32 after fabrication of the second glazing unit 32. Each of the third and fourth hooks 73, 74 extend away from the second glazing unit 32 toward the first glazing unit 31. Each of the third and fourth hooks 73, 74 may extend along the entire height of the second glazing unit 32, or alternatively may extend along only a portion of the height of the second glazing unit 32, or still alternatively plural such hooks 71, 72 may reside intermittently along such height of the second glazing unit 32.

A side edge of the first panel 21 may be fitted with a first profile 41 and the other side edge may be fitted with a second profile 42. Each of the first and second profiles 41, 42 may be linear and may extend along the entire height of the first panel 21, or alternatively may extend along only a portion of the height of the first panel 21, or still alternatively plural such first and second profiles 41, 42 may reside intermittently along such height of the first panel 21.

The first profile 41 may include a first retainer 61, configured to engage with the first hook 71 and secure the first glazing unit 31 to the first profile 41. The first profile 41 may also include a third retainer 63, configured to engage with the third hook 73 and secure the second glazing unit 32 to the first profile 41. The second profile 42 may include a second retainer 62, configured to engage with the second hook 72 and secure the first glazing unit 31 to the second profile 42. The second profile 42 may also include a fourth retainer 64, configured to engage with the fourth hook 74 and sure the second glazing unit 32 to the second profile 42.

Opposite the first retainer 61, the first profile 41 may include a first interlock 81, the first interlock 81 extending generally toward the first glazing unit 31 and defining a first gap 111 between the first interlock 81 and the first hook 71. Likewise, the first profile 41 may include a second interlock 82, the second interlock 82 extending oppositely from the first interlock 81 and defining a second gap 112 between the second interlock 82 and the third hook 73.

In some embodiments, the cross-sections of the first and second profiles 41, 42 may be identical to each other, but not identical in other embodiments.

A first connector 241 may be coupled to the first profile 41 opposite the spacing 35. Such attachment may be by a screw 309 or other fastener. In some applications, the first connector 241 may be disposed generally toward the interior side of the first panel 21.

The first connector 241 may include first and second overlaps 91, 92. First and second overlaps 91, 92 each first extend away from each other then turn toward away from the first glazing unit 31 of the first panel 21. The second overlap 92 may thus be fitted into the first gap 111. The first gap 111 and the second overlap 92 may be structured such that, when the second overlap 92 resides within the first gap 111, a portion of the first gap 111 remains. Intentionally allowing such remaining portion of first gap 111 aids in installation, as described in more detail below.

The first connector 241 also may include a screw groove 120 residing approximately at the middle of a cross-section of the first connector 241.

Two panels, such as a first panel 21 and a second panel 22, may be joined side-by-side. The second panel 22 may include a third glazing unit 33 and a fourth glazing unit 34, the third and fourth glazing units 33, 34 being separated to create between them a spacing 35. The third glazing unit 33 may be understood to face the interior of a building and the fourth glazing unit 34 may be understood to face the exterior of that building.

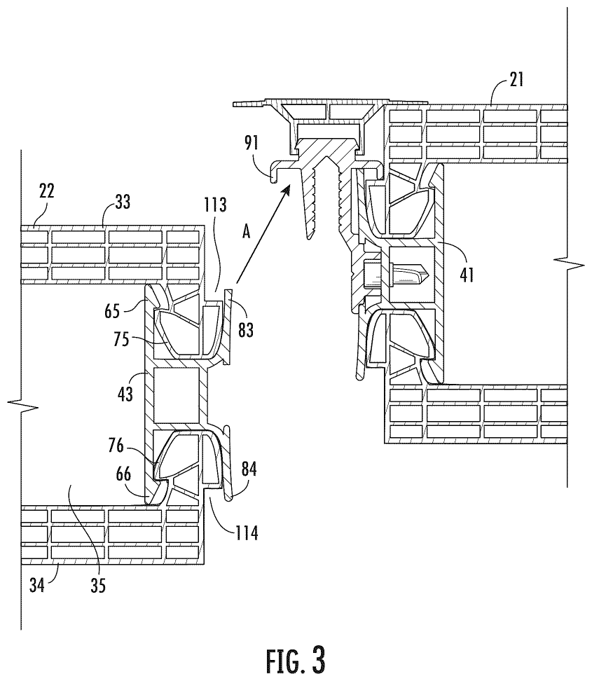

In a cross-sectional view of the second panel 22, such as that illustrated in FIGS. 3-5, at each side edge of the third glazing unit 33 there may be a hook, such as a fifth hook 75 at one edge and a seventh hook 77 at the opposite edge (not shown). Each of the fifth hook 75 and the seventh hook 77 may be integrally formed with the third glazing unit 33 or, alternatively, may be joined to the third glazing unit 33 after fabrication of the third glazing unit 33. Each of the fifth hook 75 and the seventh hook 77 may extend away from the third glazing unit 33 toward the fourth glazing unit 34. Each of the fifth hook 75 and the seventh hook 77 may extend along the entire height of the third glazing unit 33, or alternatively may extend along only a portion of the height of the third glazing unit 33, or still alternatively plural such fifth hook 75 and seventh hook 77s may reside intermittently along such height of the third glazing unit 33.

Similarly, at each side edge of the fourth glazing unit 34 of the second panel 22, there may be a hook, such as a sixth hook 76 at one edge and an eighth hook 78 (not shown) at the opposite edge. Each of the sixth hook 76 and the eighth hook 78 may be integrally formed with the fourth glazing unit 34 or, alternatively, may be joined to the fourth glazing unit 34 after fabrication of the fourth glazing unit 34. Each of the sixth hook 76 and the eighth hook 78 may extend away from the fourth glazing unit 34 toward the third glazing unit 33. Each of the sixth hook 76 and the eighth hook 78 may extend along the entire height of the fourth glazing unit 34, or alternatively may extend along only a portion of the height of the fourth glazing unit 34, or still alternatively plural such sixth hooks 76 and eighth hooks 78 may reside intermittently along such height of the fourth glazing unit 34.

One side edge of the second panel 22 may be fitted with a third profile 43 and the opposite side edge may be fitted with another profile (not shown). The third profile 43 may be linear and may extend along the entire height of the second panel 22, or alternatively may extend along only a portion of the height of the second panel 22, or still alternatively plural such third profiles 43 may reside intermittently along such height of the second panel 22.

The third profile 43 of the second panel 22 may be identical in cross-section to the first profile 41 of the first panel 21, or in other instances not identical. As to the former, the third profile 43 may include a fifth retainer 65, configured to engage with the fifth hook 75 and secure the third glazing unit 33 to the third profile 43. The third profile 43 may also include a sixth retainer 66, configured to engage with the sixth hook 76 and secure the fourth glazing unit 34 to the third profile 43.

Opposite the fifth retainer 65, the third profile 43 may include a third interlock 83, the third interlock 83 extending generally toward the third glazing unit 33 and defining a third gap 113 between the third interlock 83 and the fifth hook 75. Likewise, the third profile 43 may include a fourth interlock 84, the fourth interlock 84 extending oppositely from the third interlock 83 and defining a fourth gap 114 between the fourth interlock 84 and the sixth hook 76.

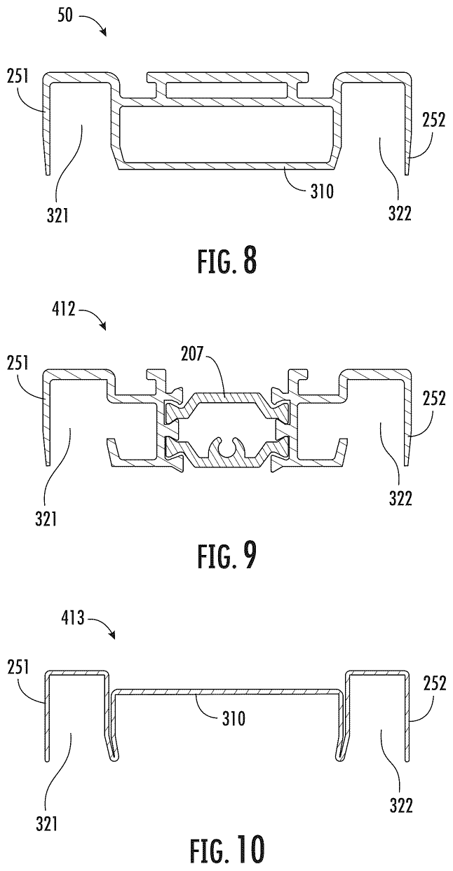

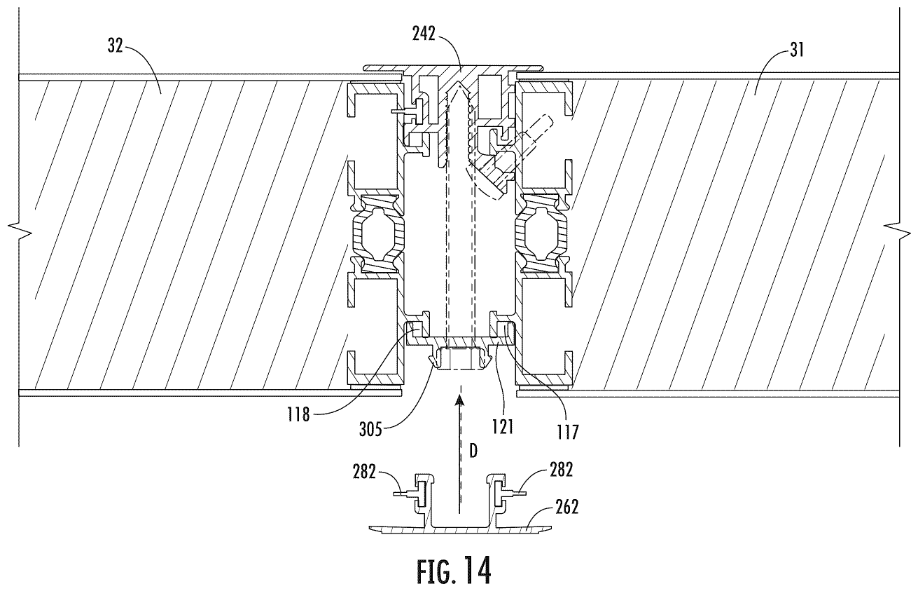

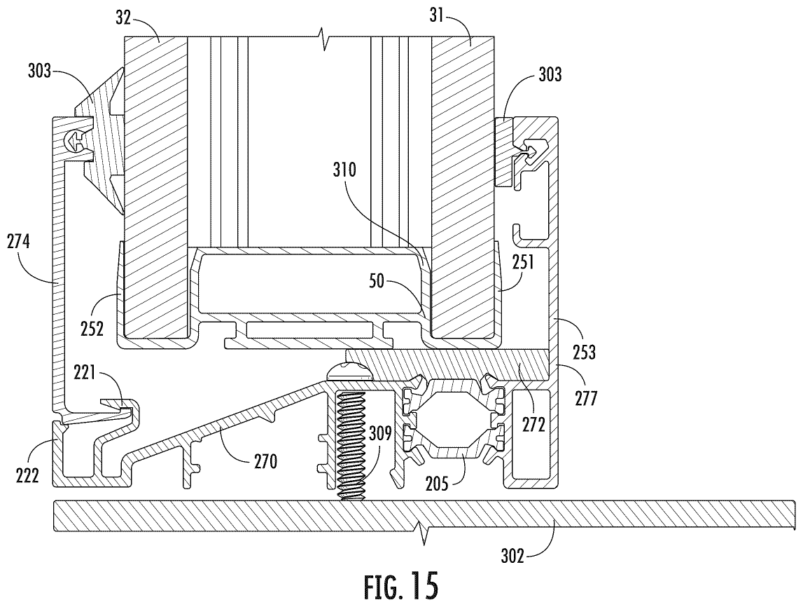

A multiwall fenestration panel, such as first panel 21, has been described above as having a first profile 41 along an edge. FIGS. 2-6 illustrate the configuration of such a first profile 41. However, alternative profiles may be used instead, such as profiles 50, 412, or 413, illustrated in FIGS. 8, 9, and 10, respectively. Profiles 50, 412, or 413 may also be used in situations in which a multiwall panel has been cut from its original size to fit a particularly sized opening—a multiwall panel of the type described herein may be reduced in size by cutting in the field. Such a profile, such as a profile 50, 412, or 413, may be affixed, even in the field, to a fenestration panel around any or all of the four sides of the fenestration panel. For example, and with reference to FIGS. 8 and 15, a profile 50 may include a first arm 251, a second arm 252, and a spacer 310. The first arm 251 and the spacer 310 may define between them a first channel 321 for receipt of the edge of the first glazing unit 31, and the second arm 252 and the spacer 310 may define between them a second channel 322 for receipt of the edge of the second glazing unit 32. The profile illustrated in FIG. 8 may be formed of extruded polycarbonate plastic. The profile 413 illustrated in FIG. 9 may be formed of aluminum with a thermal break. More particularly, a profile 413 may include a first arm 251, a second arm 252, and a seventh thermal break 207. The first arm 251 and the seventh thermal break 207 may define between them a first channel 321 for receipt of the edge of the first glazing unit 31, and the second arm 252 and the seventh thermal break 207 may define between them a second channel 322 for receipt of the edge of the second glazing unit 32. The thermal break 207 (like thermal breaks 201-206 described hereinbelow) is fabricated from material having low thermal conductivity to provide a thermal “short circuit” between the inside and outside of the building, improving U values and reducing condensation risk. The profile 414 illustrated in FIG. 10 may be formed of roll formed stainless steel. More particularly, a profile 414 may include a first arm 251, a second arm 252, and a spacer 310. The first arm 251 and the spacer 310 may define between them a first channel 321 for receipt of the edge of the first glazing unit 31, and the second arm 252 and the spacer 310 may define between them a second channel 322 for receipt of the edge of the second glazing unit 32. Thus the term “profile means” includes the structures described in this paragraph, as well as those profiles illustrated in FIGS. 2-6, 8-18, and 21-22.

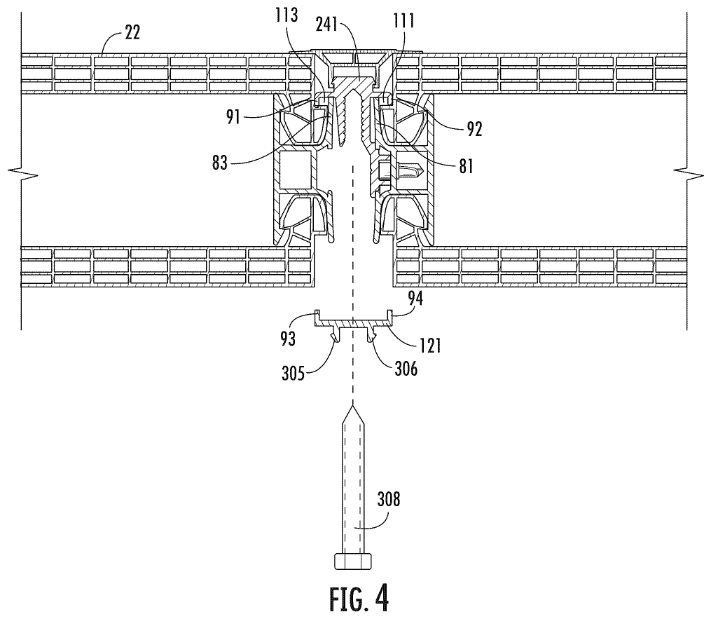

A first panel 21 and a second panel 22 may thereby be joined, such as illustrated by direction A in FIG. 3. The first overlap 91 of the first connector 241 may be fitted into the third gap 113. The third gap 113 and the first overlap 91 may be structured such that, when the first overlap 91 resides within the third gap 113, a portion of the third gap 113 remains open. A clamping bar 121 may then be joined to the first connector 241 (see FIG. 4). The clamping bar 121 may have a third overlap 93 and a fourth overlap 94. The third overlap 93 may be fitted into the fourth gap 114 and the fourth overlap 94 may be fitted into the second gap 112. An assembly screw 308 may then be passed through an aperture (not shown) in the clamping bar 121 and tightened within the screw groove 120, pulling the clamping bar 121 and the first connector 241 toward each other. The joinder of such a first panel 21 and a second panel 22 in such a fashion as described hereinabove, with a clamping bar 121 of the described configuration, has been found to provide a structurally-additive, strong, secure, yet easily assembled connection.

A first cover 261 may be attached to the first connector 241 opposite the clamping bar 121, concealing the first connector 241 from view and providing an aesthetically pleasing surface between a first panel 21 and a second panel 22.

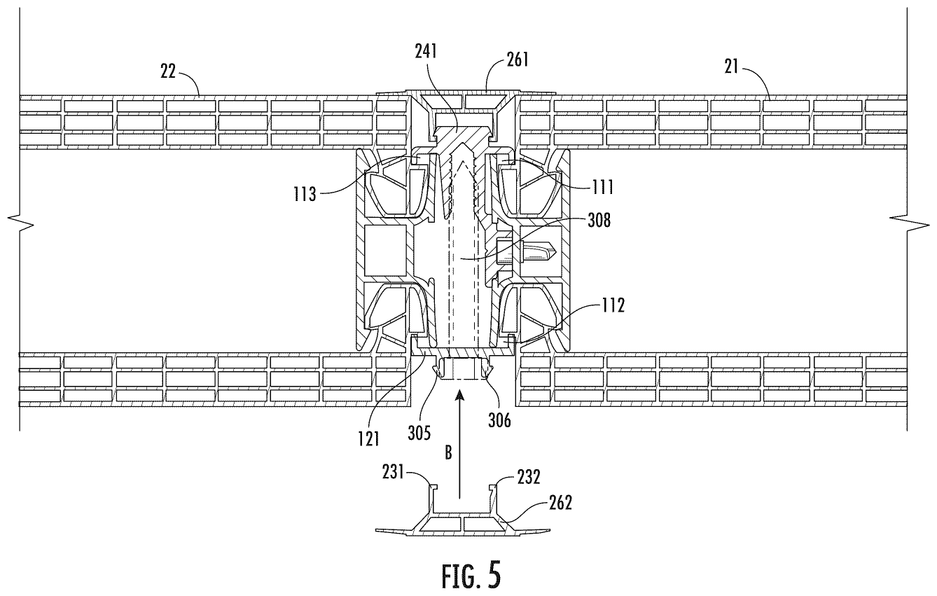

The clamping bar 121 may include a first prong 305 and a second prong 306, each projecting away from the first connector 241. A second cover 262 may be provided, the second cover 262 including a first clip 231 and a second clip 232 arranged to engage with and attach to the first prong and the second prong 306, respectively, to attach the second cover 262 to the clamping bar 121 such as by direction B in FIG. 5.

As described above, with the first panel 21 and second panel 22 joined together, portions of the first gap 111, second gap 112, third gap 113, and fourth gap 114 remain partially open. Such remaining open portions of the first gap 111, second gap 112, third gap 113, and fourth gap 114 thus allow for thermal expansion between the respective components, as well as a limited amount of flexion of the first panel 21 and the second panel 22 relative to each other to account for, for example, wind load to a building in which such an assembly may be installed. It has been found, also, that intentionally allowing first gap 111, second gap 112, third gap 113, and fourth gap 114 to remain partially open provide what those of skill in the art may refer to as a “dimensional allowance” and/or a “functional tolerance,” permitting easier installation of these fenestration panels.

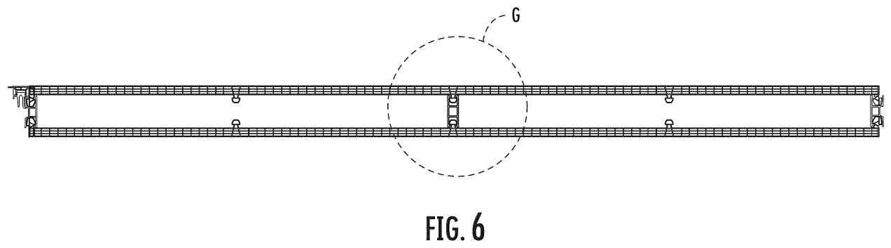

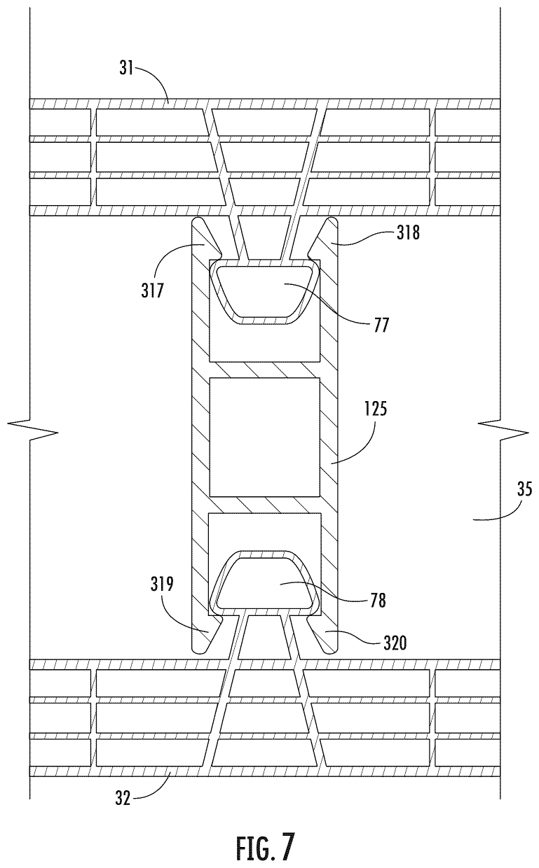

The strength of the present system allows for use of panels of greater width than conventional systems currently in use (which are often limited by their design to twenty-four inches (610 millimeters) wide). In some instances, for example with a panel 21 of a width such as forty-eight inches (1219 millimeters) as illustrated in FIG. 6, it may be desirable to add strengthening between the two glazing units 31, 32. Such a strengthening may be accomplished by placement of an intermediate support 125. Referencing FIG. 7, first glazing unit 31 may be configured to include a seventh hook 77, seventh hook 77 having been integrally formed with the first glazing unit 31 or, alternatively, having been joined to the first glazing unit 31 after fabrication of the first glazing unit 31. Seventh hook 77 may project toward the second glazing unit 32. An eighth hook 78, projecting toward the first glazing unit 31 from the second glazing unit 32, may be integrally formed with the second glazing unit 32 or, alternatively, may be joined to the second glazing unit 32 after fabrication of the second glazing unit 32. The seventh hook 77 and the eighth hook 78 may reside opposite each other across spacing 35, pointing toward each other, and located between the side edges of a panel 21. In some embodiments, a single pair of seventh hook 77 and eighth hook 78 may reside approximately midway between the two side edges of a panel 21; in other embodiments, such as that of FIG. 6, plural pairs of seventh hooks 77 and eighth hooks 78 may reside along the width of a panel 21 between its two side edges. Note that a particular fenestration panel may include plural pairs of opposing hooks, such as is illustrated in FIG. 6, but not all of such pairs being in use by affixing an intermediate connector between them, as individual applications may warrant. An intermediate support 125 may have a seventh retainer 317 and an eighth retainer 318, configured to engage the seventh hook 77. Additionally, the intermediate support 125 may have a ninth retainer 319 and a tenth retainer 320, configured to engage the eighth hook 78. One or more intermediate connectors 125 may be installed during assembly of a panel, such as first panel 21, for example by snap-fit engagement with seventh hook 77 and eighth hook 78. Alternatively, one or more intermediate connectors 125 may be inserted in spacing 35 between first glazing unit 31 and second glazing unit 32 from the top or bottom edge of a previously-assembled panel, such as first panel 21. Thus, such an intermediate support 125 may serve to strengthen the first panel 21, maintain the spacing 35 between the first glazing unit 31 and the second glazing unit 32, and reduce flexion of the first panel 21.

It will be noted that the system disclosed in the preceding paragraphs uses no adhesive tapes or sealants, which is another advantageous aspect inasmuch as adhesive tapes and sealants may degrade over time and, for example, thereby allow water intrusion into a building's interior.

### B. FRP Panel

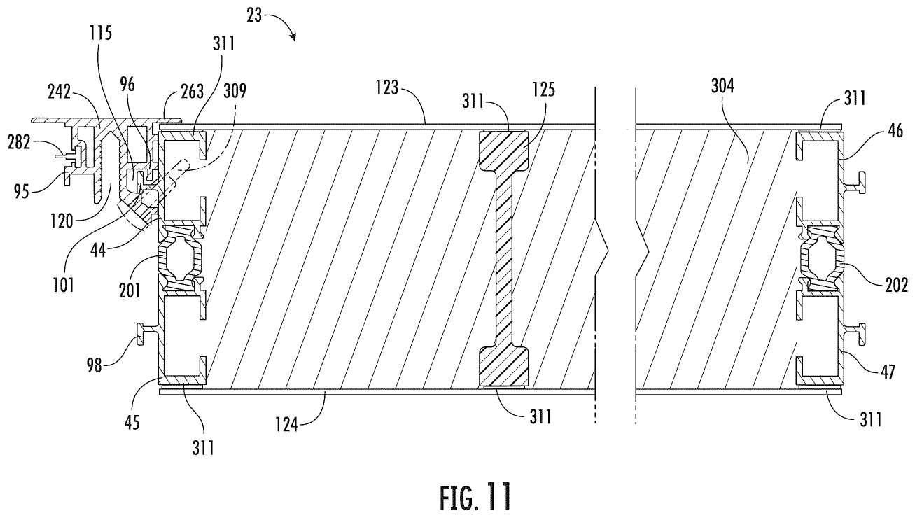

A fiberglass reinforced plastic (“FRP”) panel, such as a third panel 23, is a second example of a fenestration panel. The third panel 23 may be understood to have an inner skin 123, an outer skin 124, and an internal grid 304 between the inner skin 123 and the outer skin 124. The internal grid 304 may be, for example, glass fiber infill. Each of the inner skin 123, outer skin 124, and an internal grid 304 may be transparent, translucent, opaque, or combinations of transparent, translucent, and opaque. FIGS. 11-14 illustrate certain aspects of embodiments of such a third panel 23. Such a fenestration panel 23 may be oriented in a vertical configuration in an opening in a building, such as for a window, as for a curtain wall, or as for a light transmitting wall, or in a sloped configuration such as for a skylight.

One side edge of the third panel 23 may be fitted with a fourth profile 44 and a fifth profile 45, with a first thermal break 201 residing between and connected to the fourth profile 44 and the fifth profile 45. The fourth profile 44 may be attached to the inner skin 123 by tape 311 opposite the first thermal break 201. The fifth profile 45 may be attached to the outer skin124 by tape 311 opposite the first thermal break 201. Each of the fourth and fifth profiles 44, 45 may be linear and may extend along the height of the third panel 23, or alternatively may extend along only a portion of the entire height of the third panel 23, or still alternatively plural such first and second profiles 44, 45 may reside intermittently along such height of the third panel 23.

Extending from the fourth profile 44, and turning away from the first thermal break 201, may be an eleventh overlap 101. Similarly, extending away from the fifth profile 45, and turning away from the first thermal break 201, may be an eighth overlap 98.

A second connector 242 may be fixed to the fourth profile 44, for example by a screw 309 passing into the fourth profile 44. The second connector 242 may include a sixth overlap 96 that extends toward the first thermal break 201. The sixth overlap 96 of the second connector 242 may be interfitted alongside the eleventh overlap 101 of the fourth profile 44, and configured so that, when interfitted, there remains a fifth gap 115 proximate to the sixth overlap 96 and the eleventh overlap 101. The second connector 242 may also include a fifth overlap 95, extending oppositely from, and a mirror image of, the sixth overlap 96.

The second connector 242 may include an integral third cover 263.

In some embodiments, the cross-sections of the fourth and fifth profiles 44, 45 may be identical, but not identical in other embodiments.

The second connector 242 also may include a screw groove 120 residing approximately at the middle of a cross-section of the second connector 242.

The side edge of the third panel 23 opposite the fourth profile 44 and the fifth profile 45 may be fitted with a sixth profile 46 and a seventh profile 47, the sixth profile 46 being a mirror image of the fourth profile 44 and the seventh profile 47 being a mirror image of the fifth profile 45, and with a second thermal break 202 residing between the sixth profile 46 and the seventh profile 47.

The first thermal break 201 and the second thermal break 202 may provide a thermal “short circuit” between the inside and outside of the building, improving U values and reducing condensation risk.

With some applications, particularly applications involving FRP panels of great width, an intermediate connector 125 may be fitted into the third panel 23, at a location between its side edges and between the inner skin 123 and the outer skin 124. The intermediate connector 125 may extend only a portion of the height of the third panel 23, or the entirety of that height. The intermediate connector 125 may be secured to the inner skin 123 and the outer skin 124 with tape 311. Such an intermediate connector 125 may strengthen the third panel 23, maintain the spacing 35 between the inner skin 123 and the outer skin124, and inhibit flexion of the third panel 23. The strength of such a configuration allows for use of FRP panels of greater width than those systems currently in use, which are often limited by their design to twenty-four inches wide (610 millimeters). In some instances, for example with a panel 23 of a width such as forty-eight inches (1219 millimeters) may be used, with the invention disclosed herein.

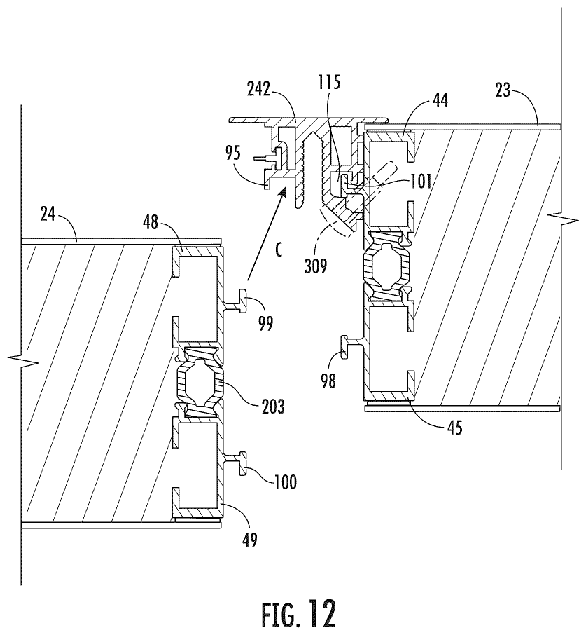

With particular applications, two panels, such as third panel 23 and fourth panel 24, may be joined side-by-side as illustrated in FIGS. 12-14. The fourth panel 24 may include along its side edge an eighth profile 48 and a ninth profile 49, matching fourth profile 44 and fifth profile 45, respectively. A third thermal break 203 may reside between the eighth profile 48 and the ninth profile 49. The eighth profile 48 might may include a ninth overlap 99, and the ninth profile 49 may include a tenth overlap 100. Flexible seals 282 may seal the interface between the second connector 242, fourth profile 44, and eighth profile 48.

The third panel 23 and the fourth panel 24 may thereby be joined, such as by direction C in FIG. 12. The fifth overlap 95 of the second connector 242 may be interfitted alongside the ninth overlap 99 of the eighth profile 48, the two configured so as to leave a sixth gap 116 remaining proximate to the fifth overlap 95 and the ninth overlap 99.

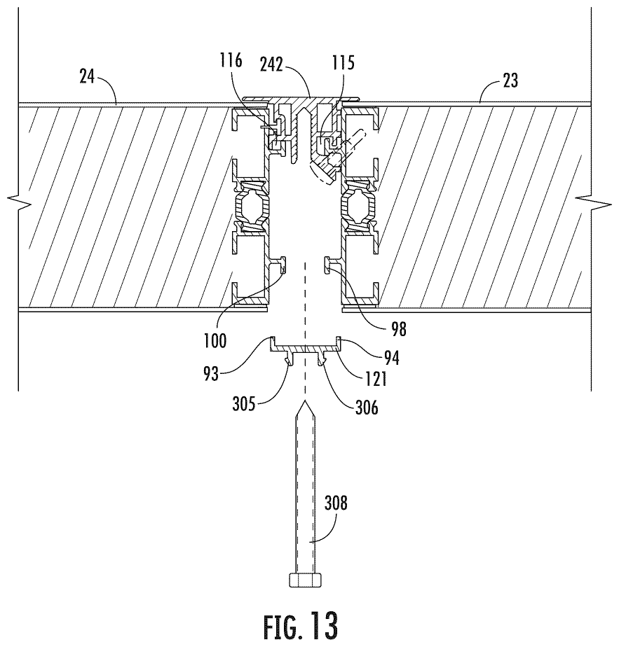

A clamping bar 121 may be joined to the assembly as illustrated in FIG. 13. The clamping bar 121 may have a third overlap 93 and a fourth overlap 94. The third overlap 93 may be fitted alongside the tenth overlap 100 of the ninth profile 49 and the fourth overlap 94 may be fitted alongside the eighth overlap 98 of the fifth profile 45. An assembly screw 308 may be passed through an aperture in the clamping bar 121 and tightened within the screw groove 120, pulling the clamping bar 121 and the second connector 242 toward each other. The joinder of such a third panel 23 and a fourth panel 24 in such a fashion as described hereinabove, with a clamping bar 121 of the described configuration, has been found to provide a structurally-additive, strong, secure, yet easily assembled connection.

The clamping bar 121 may include a first prong 305 and a second prong 306, each projecting away from the assembly. A second cover 262 may be provided, the second cover 262 including a first clip 231 and a second clip 232 configured to engage with and attach to the first prong 305 and the second prong 306, respectively, to attach the second cover 262 to the clamping bar 121. Flexible seals 282 may seal the interface between the second cover 262, fifth profile 45, and ninth profile 49.

As described above, with the first panel 21 and second panel 22 joined together, portions of the first gap 111, second gap 112, third gap 113, and fourth gap 114 remain partially open. Such remaining open portions of the first gap 111, second gap 112, third gap 113, and fourth gap 114 thus allow for thermal expansion between the respective components, as well as a limited amount of flexion of the first panel 21 and the second panel 22 relative to each other to account for, for example, wind load to a building in which such an assembly may be installed. It has been found, also, that intentionally allowing first gap 111, second gap 112, third gap 113, and fourth gap 114 to remain partially open provide what those of skill in the art may refer to as a “dimensional allowance” and/or a “functional tolerance,” permitting easier installation of these fenestration panels.

### C. Assembly

Fenestration panels, such as aforedescribed exemplary multiwall panels and FRP panels, may be attached to a building by several methods, including the following. Some of the assembly methods and steps, such as connecting profiles to the fenestration panels and connecting fenestration panels to each other, have been described above. What follows is a description of the systems and steps of installing fenestration panels in a building.

With reference to FIG. 15, a sill 270 may be attached, for example by a screw 309, to a building element 302 at the bottom of the building opening. On the exterior side of the sill 270, a first coupler 221 and a second coupler 222 may be included. On the interior side of the building opening, a first frame 277 may be attached to the sill 270 by a fifth thermal break 205 joined to both the sill 270 and to the first frame 277 and residing between them. The first frame 277 may include a third arm 253 projecting upwards, carrying an exterior-facing gasket 303 near the upper terminus of the third arm 253. A setting block 272 may be positioned above and positioned upon the sill 270 and/or the first frame 277. The bottom profile of a fenestration panel, be it a profile 41, 50, 412, 413, or otherwise, may then be rested upon the setting block 272. So positioned, the interior side of the fenestration panel, for example first glazing unit 31 of the multiwall panel described hereinabove, may reside against the gasket 303 carried near the upper terminus of the third arm 253 of the first frame 277. A snap cap 274 may be attached to the sill 270 by interfitting the snap cap 274 with the first coupler 221 and the second coupler 222. A gasket 303 may be carried near the upper terminus of the snap cap 274, positioned against the exterior surface of the second glazing unit 32. The right and left sides of the fenestration panel may be attached to a building by the same or similar methodology and components described in this paragraph.

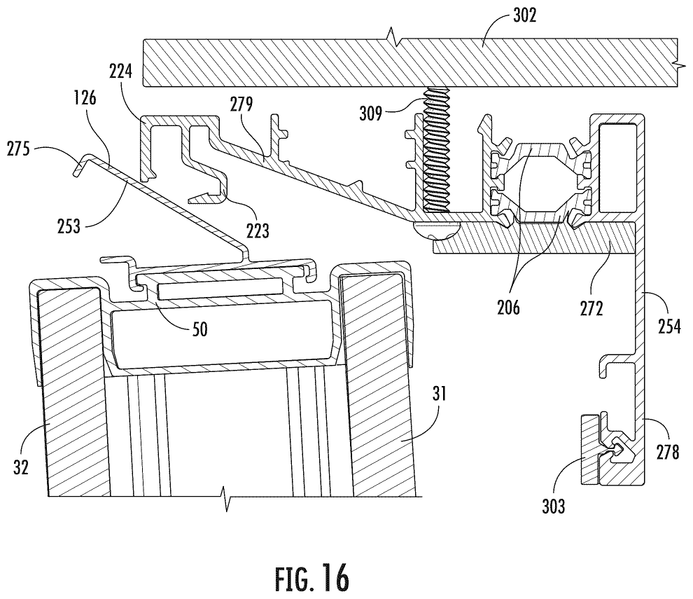

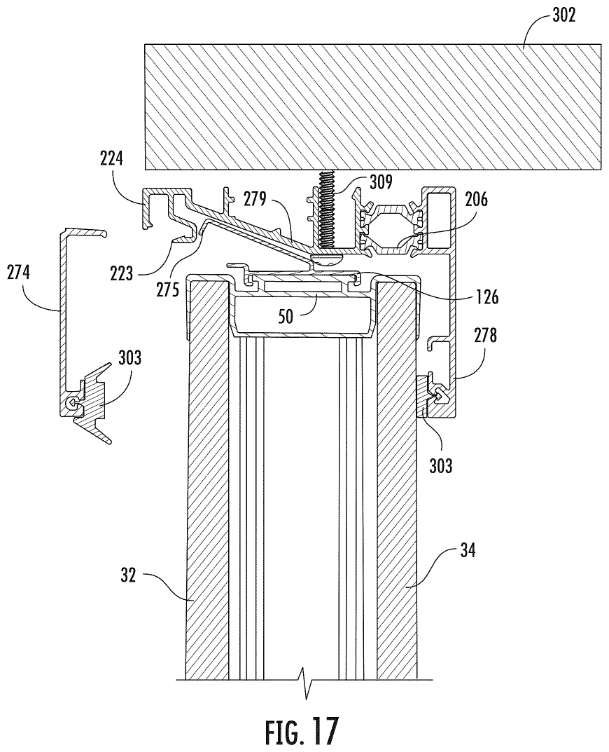

As to attachment of the top of the fenestration panel to the building, with reference to FIG. 16 a header 279 may be attached, for example by a screw 309, to a building element 302 at the top of the building opening. In some embodiments, the header 279 may have the same cross-sectional configuration as the cross-sectional configuration of the sill 270, in which case on the exterior side of the header 279, a third coupler 223 and a fourth coupler 224 may be included. On the interior side of the building opening, a second frame 278 may be attached to the header 279 by a sixth thermal break 206 joined to both the header 279 and to the second frame 278 and residing between them. In some embodiments, the second frame 278 may have the same cross-sectional configuration as the cross-sectional configuration of the first frame 277. The second frame 278 may include a fourth arm 254 projecting downwards, carrying an exterior-facing gasket 303 near the lower terminus of the fourth arm 254. A setting block 272 may be positioned below the header 279 and the second frame 278. Upon installation of the panel, the top profile of a fenestration panel, be it profile 41, 50, 412, 413, or otherwise, may abut against the setting block 272. So positioned, the interior side of the glazing unit may reside against the gasket 303 carried near the lower terminus of the fourth arm 254 of the second frame 278. As illustrated in FIGS. 16 and 17, a third hand 126 may be attached to the top profile 50 (or such other profile as may have been used, as explained herein) of the fenestration panel. In cross-section, the third hand 126 may include a resilient third arm 253 that may be compressed downward toward the fenestration panel. The third hand 126 may terminate in a downwardly extending finger 275. As the top of the fenestration panel is pushed toward the gasket 303 carried near the lower terminus of the fourth arm 254, the third hand 126 may be configured to, first, compress downwardly so as to allow passage of the third hand 126 past the third coupler 223 then, second, to resiliently spring back up on the interior side of the third coupler 223, the finger 275 of the third hand 126 abutting against the interior side of the third coupler 223, as illustrated in FIG. 17, so as to hold the fenestration panel in place in the building opening. Thus, use of such a third hand 126 simplifies installation of such a fenestration panel, reduces the labor required for installation, and provides for an assured fitting of the fenestration panel into the building opening.

The FRP panel described hereinabove and illustrated in FIGS. 11-14 may be attached to a building opening in the same or similar manner, and with the same or similar fittings, as described above for multiwall panel embodiment illustrated in FIGS. 2-7 and the attachments illustrated in FIGS. 15-17.

A snap cap 274 may be attached around the perimeter of the in-place fenestration panel. With exemplary reference to FIG. 15 illustrating the bottom of the fenestration panel, a snap cap 274 may be attached to the sill 270 by interfitting with the third coupler 223 and the fourth coupler 224. Still further, in some embodiments, snap cap s 274 attached to the bottom, to the sides, and to the top of the panel may all have the same cross-sectional configuration.

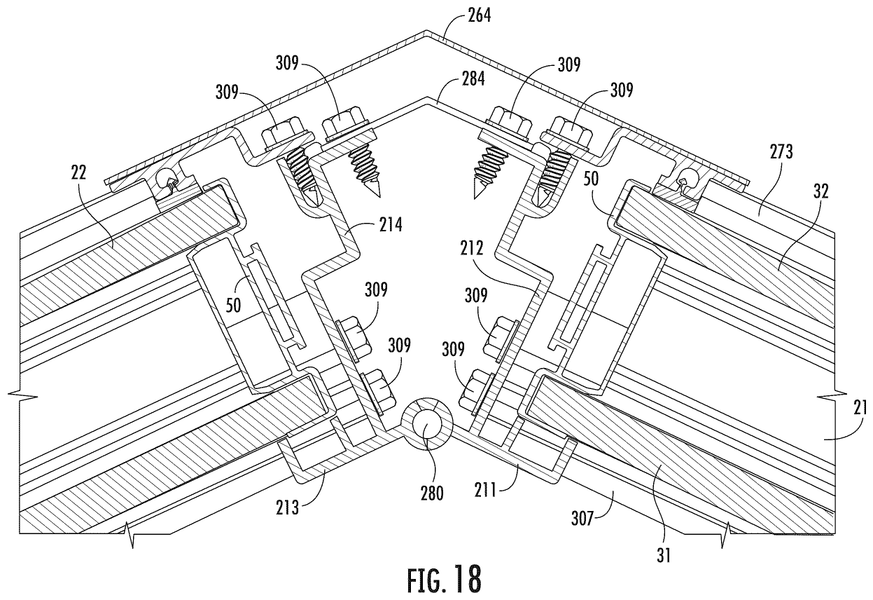

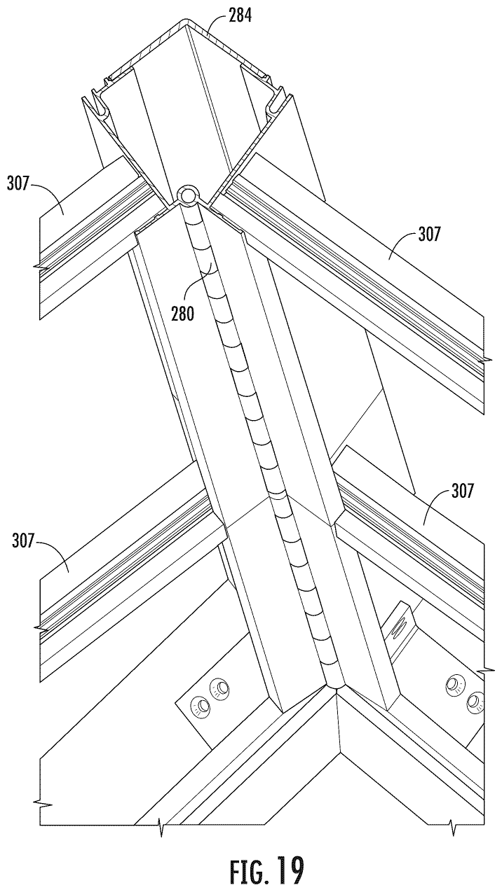

Certain aspects of the fenestration panels and attachment systems as aforedescribed may be oriented in a sloped configuration, such as with a skylight, as will now be described. FIGS. 18-22 illustrate certain aspects of embodiments of such a sloped configuration.

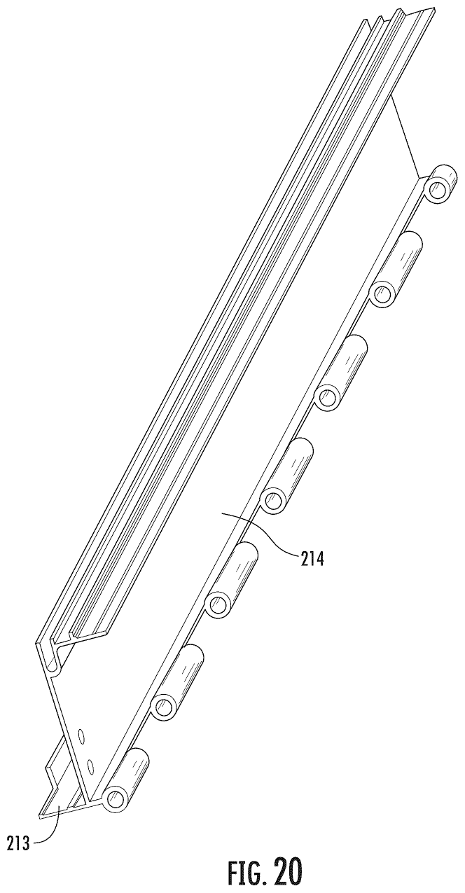

With reference to FIG. 18, a first panel 21, comprising an interior-facing first glazing unit 31 and an exterior-facing second glazing unit 32, may be provided. A similarly structured second panel 22 may also be provided. A ridge hinge 280, which is referred to as a “piano hinge” by some persons of skill in the art, may join the first panel 21 and the second panel 22, as illustrated in FIGS. 19 and 20. The ridge hinge 280 may be configured to allow the first panel 21 and the second panel 22 to be folded against each other for compact shipment. Furthermore, the ridge hinge 280 may allow the first panel 21 and the second panel 22 to be oriented at a range of slopes, for example from a 3/12 pitch to a 12/12 pitch depending upon user preference and the skylight roof opening dimensions—the ridge hinge 280 allows first panel 21 and second panel 22 to be opened to a larger angle between them for larger roof openings, and a smaller angle between them for smaller roof openings. The ridge hinge 280 may include a first leaf 211 extending along the interior side of the first glazing unit 31. The ridge hinge 280 may also include a second leaf 212 extending transverse across an end of the first panel 21 and attached to the first panel 21, for example by screws 309. The ridge hinge 280 may further include a third leaf 213 extending along the interior side of the second panel 22. The ridge hinge 280 may additionally include a fourth leaf 214 extending transverse across an end of the second panel 22 and attached to the second panel 22, for example by screws 309. A set splice 284 may bridge across and be fastened to the second leaf 212 and the fourth leaf 214. Set splice 284 may be fabricated so as to allow bending along its middle in the field by installers, to meet particular applications. A ridge closure 264 may be attached across the top of the junction between the first panel 21 and the second panel 22, above the set splice 284. Ridge closure 264 may likewise be fabricated so as to allow bending along its middle in the field by installers, to meet particular applications.

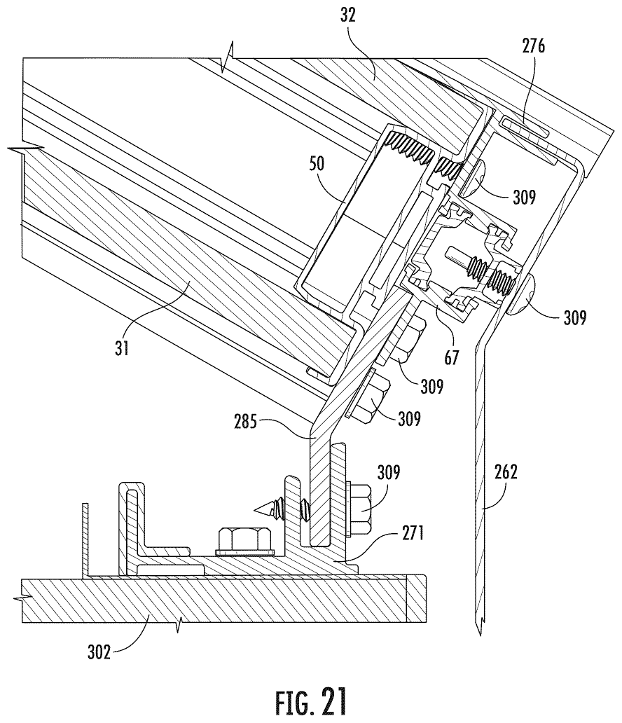

In a sloped panel application, the first panel 21 and the second panel 22 may be attached to the building as follows. With reference to FIG. 21, a sill base 271 may be attached to a building element 302. A sill angle 285, residing at a configuration to match the chosen slope angle of the first panel 21, may then be attached to the sill base 271 and to the first panel 21, for example by screws 309. Flashing 276 may be applied to the second glazing unit 32, fixing the flashing 276 by a screw 309 to the profile 50. A sill retainer 67 may be attached to the fenestration panel's bottom profile, and, in turn, a sill closure 262 attached to the sill retainer 67.

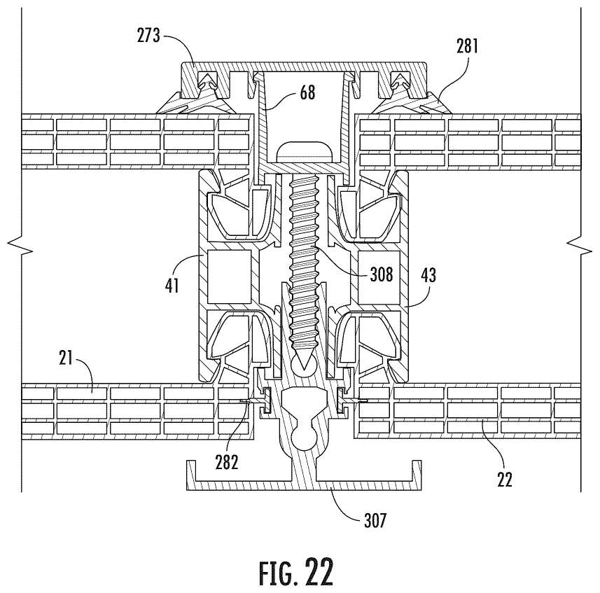

In particular applications, side-by-side panels may be used in a sloped configuration. Describing such as to multiwall panels to illustrate the arrangement, a first panel 21 may be joined side-by-side with a second panel 22 to form, for example, a wider skylight. Such joinder may be accomplished as follows. As illustrated in FIG. 22, a first panel 21 side edge may terminate by use, for example, of a first profile 41, aforedescribed. A second panel 22 side edge may likewise terminate with a third profile 43, aforedescribed. FIG. 22 is understood to illustrate a cross-sectional view of such use in a sloped orientation. A rafter 307 may be interfitted with the first profile 41 and the third profile 43 from the interior side of the assembly. On the exterior side of the assembly, a rafter retainer 68 may be screwed together with the rafter 307, and a joint cap 273 attached, for example by snapfit engagement, to the rafter retainer 68. Exterior seals 281 may seal the joint cap 273 with the first panel 21 and the second panel 22. Flexible seals 282 may seal the interface between the rafter 307, first panel 21, and second panel 22.

It has been further found that the aforedescribed configurations and assembly steps provide for easy removal of a single panel from a series of so-joined panels, for example for replacement of a single panel. In use, it would be anticipated that two or more panels would be joined together in manner aforedescribed. As an illustrative example, consider an installed, assembled series of six multiwall panels, including panels 21 and 22, joined together. In this hypothetical, panel 21 may be the third panel in the series, having a third panel joined to it on the opposite side from panel 22 and a fourth panel is joined to the third panel on the opposite side from panel 21. Panel 22 may be the fourth panel in the series, having a fifth panel joined to it on the opposite side from panel 21 and a sixth panel is joined to the fifth panel on the opposite side from panel 22. It should be noted incidentally that, depending upon user preference, any one of such first-sixth panels may be a multiwall panel and its adjacent panel may be an FRP panel-the present technology easily allows for mixing of panels. Suppose panel 22 must be replaced, for example because of damage to it. In prior art assemblies, to remove panel 22 would require removal of either the fifth and sixth panels or panel 21 and the third panel and the fourth panel. With the present technology, by contrast, to remove panel 22 would require only disassembly of the respective assembly screws 308 along the two side edges of panel 22, removal of the clamping bars 121 along the two side edges of panel 22, and removal of first cover 261 and second cover 262. Panel 22 may then be removed from the assembly with disturbing the installation of the previously-assembled/installed other five panels.

Thus the present technology discovers fenestration panels and systems that provide durable, efficient, reliable, and simple yet versatile solutions to the difficulties and shortcoming encountered before. They have a single common structure, with the same simplified installation methods, for use in mounting various types of fenestration panels to buildings, accommodating both vertical (“curtainwall”) and sloped applications. The systems permit structurally reliable panel widths of up to forty-eight inches (1219 millimeters). The systems are scalable to accommodate varied sizes and configurations, and build structural support into the fenestration panel itself. The structural framework is versatile for architects and designers, and is intuitive for installers, even providing a mechanism to hold the panel in place in a building opening during the installation process. Uniform structures are provided for capturing the edges of fenestration panels and the use of adhesive tapes and sealants is minimized. And the system allows for the removal of individual fenestration panels anywhere along the width of a multi-panel installation without the need to remove other panels.

It should be appreciated that, in the above description of embodiments, various features are sometimes grouped together in a single embodiment, figure, or description for the purpose of streamlining the disclosure and aiding in the understanding of one or more of the various inventive aspects. This method of disclosure, however, is not to be interpreted as reflecting an intention that any claim requires more features than are expressly recited in that claim. Moreover, any components, features, or steps illustrated and/or described in a particular embodiment herein, can be applied to or used with any other embodiment. Thus, it is intended that the scope of the inventions herein disclosed should not be limited by the particular embodiments described above, but should be determined only by a fair reading of the claims that may issue from the benefit of the within disclosure.

1. A fenestration panel system, comprising:
a fenestration panel, the fenestration panel having side edges;
profile means for providing attachment to a side edge of the fenestration panel;
a connector configured to engage with the profile means; and
a clamping element configured to engage with the profile means and with the connector.

2. The fenestration panel system of claim 1, in which the fenestration panel resides sloped.

3. The fenestration panel system of claim 1, in which the fenestration panel greater than thirty-five inches (889 millimeters) in width.

4. The fenestration panel system of claim 1, further including a third hand configured for attachment to the fenestration panel.

5. The fenestration panel system of claim 1, in which the fenestration panel is a multiwall panel having two glazing units.

6. The fenestration panel system of claim 1, further including an intermediate connector disposed within the panel and between the side edges.

7. The fenestration panel system of claim 1, in which the fenestration panel system is devoid of tape, caulk, and sealant.

8. The fenestration panel system of claim 1, in which the fenestration panel is a multiwall panel having two glazing units, each glazing unit carrying a hook residing proximate to a side edge, each hook extending toward the other glazing unit, and both hooks connected to the profile means.

9. A fenestration panel system, comprising:
a fenestration panel having a first side, a opposite second side, and a side edge between the first and second sides;
a profile carried by the side edge, the profile including a first overlap extending outboard from the profile;
a connector, the connector having a second overlap extending outboard from the connector and configured to interfit with the first overlap to mate the connector with the profile; and
a clamping element, the clamping element configured for attachment to the connector.

10. The fenestration panel system of claim 9, wherein, upon mating the connector with the profile and attaching the clamping element to the connector, the connector resides proximate to the first side and the clamping element resides proximate to the second side.

11. The fenestration panel system of claim 9, in which the profile includes an aperture adapted for receipt of a fastener from the clamping element.

12. The fenestration panel system of claim 9, in which fenestration panel system resides in a sloped orientation.

13. The fenestration panel system of claim 9, in which the fenestration panel is a multiwall panel having two glazing units, each glazing unit carrying a hook residing proximate to the same side edge, each hook extending toward the other glazing unit, and both hooks interfitted with the profile.

14. The fenestration panel system of claim 9, in which the fenestration panel is fabricated of fiberglass reinforced plastic.

15. The fenestration panel system of claim 9, in which an intermediate connector resides within the panel and distal to the side edge.

16. A fenestration panel system, comprising:
first and second fenestration panels, each having opposing side edges and each having an exterior surface and an opposing interior surface;
a first profile carried by a side edge of the first panel;
a second profile carried by a side edge of the second panel;
the first and second profiles being identical to each other;
a connector coupled to each of the first and second profiles;
a clamping bar attached to the connector;
the connector residing proximate to one of the exterior surface and the interior surface, and the clamping bar residing opposite the connector and proximate to the other of the exterior surface and the interior surface.

17. The fenestration panel system of claim 16, in which each fenestration panel is greater than thirty-five inches (889 millimeters) in width.

18. The fenestration panel system of claim 16, in which the second panel is removable from the fenestration panel system without removal of the first panel.

19. The fenestration panel system of claim 16, further including a third hand attached to one of the fenestration panels.

20. The fenestration panel system of claim 16, in which the connector and the first profile provide a gap between them that allows a functional tolerance.
